(19) United States
(12) Patent Application Publication
(10) Pub. No.: US 2005/0097064 A1
(43) Pub. Date: May 5, 2005

(54) Method and apparatus to determine product weight and calculate price using a camera

(76) Inventor: Todd C. Werden, Sandy Hook, CT (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/699,770

(22) Filed: Nov. 4, 2003

(51) Int. Cl. G06F 17/60

(52) U.S. Cl. 705/400

(57) ABSTRACT

Products that are priced by weight are detected and identified by type by a camera. The camera is used to determine as the total size (volume) of the product. Total density of the product is found by using a look up table in a database, relating size to weight for each product. The total price is then calculated by multiplying total weight by the unit price. This method and apparatus can be applied both to cashier-assisted check out and to self-checkout, whereby the self-checkout customer need only place the product on the moving conveyor in order for pricing to occur.

### BACKGROUND OF THE INVENTION

1. Field of the Invention

The present invention generally relates to retail sales of commodities priced by weight and, more particularly, to a method and apparatus to determine product weight and calculate price using a camera instead of a scale.

2. Background Description

The current state of the art for measuring and determining the price of variable weight items (e.g., vegetables in grocery stores) involves the entry of an item code (usually found on a sticker placed on the product), followed by placing the item(s) on a scale to determine total weight. The cost per unit (i.e., selling quantity) is retrieved using the product code and multiplied by the weight to determine total price. This solution requires that expensive scales be integrated into the check out system, and the cashier must keypunch the correct item code into the computer. In the case of self checkout, the customer must usually use a screen of some sort to select the product from a list, then place the item on the scale to determine weight before moving it to a conveyor belt, a process involving several steps.

### SUMMARY OF THE INVENTION

It is therefore an object of the present invention to provide a simpler, more automated method and apparatus for determining the price of commodities priced by weight.

According to the invention, for products that are priced by weight (e.g., vegetables), a camera is used instead of a scale at point of purchase to calculate total price. The camera is used to visually identify the product as well as the total size (volume) of the product. Total density is found by using a look up table in a database, relating size to weight for each product. The total price can then be calculated by multiplying total weight by the unit price. This method and apparatus can be applied both to cashier-assisted check out and to self-checkout, whereby the self-checkout customer need only place the product on the moving conveyor in order for pricing to occur.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a pictorial representation of the apparatus according to the invention;

FIG. 2 is a block diagram showing the principle components of the apparatus according to the invention; and

FIG. 3 is a flow diagram showing the process implemented by the invention.

### DETAILED DESCRIPTION OF A PREFERRED EMBODIMENT OF THE INVENTION

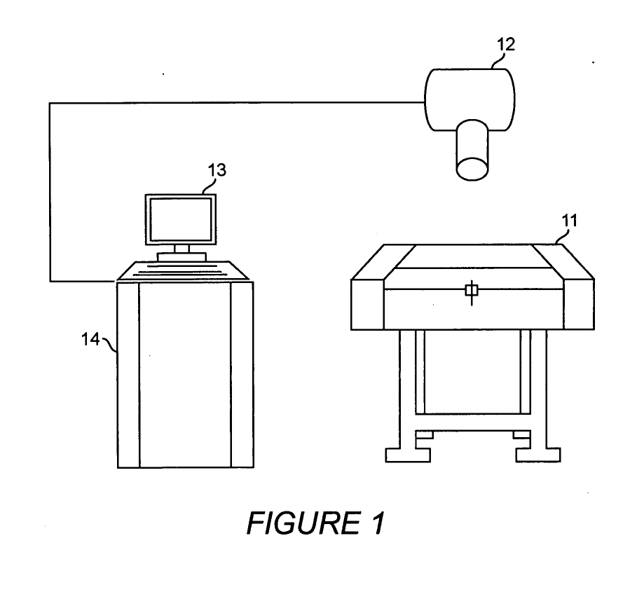

Referring now to the drawings, and more particularly to FIG. 1, there is shown a pictorial representation of one embodiment of the invention. A conveyor 11 transports products past a camera 12 which detects the type and size of the product. The camera 12 is shown in the drawing as above the conveyor, but may be located anywhere that there is an unobstructed view of the product on the conveyor. Moreover, more than one camera may be used, or a camera fitted with spaced apart lenses to generate a stereoscopic view of the product may be used. The camera 12 generates a digitized image of the product, and this image is used to both identify the product by type and to determine the total volume of the product. The information generated by the camera 12 is conveyed to a computer terminal 13 on an adjacent pedestal 14. The computer terminal 13 may include a display, which shows the item and price, and optionally a printer (not shown), which prints out a running total for all purchases. The computer terminal 13 is connected to a server (not shown) that includes a database of lookup tables, including a lookup table of densities for several products. The server also typically performs other back office activities, such as inventory control.

In operation, a customer (or sales clerk) places a product on the conveyor 11 which transports the product past the camera 12. The camera 12 detects the product on the conveyor 11 and determines the type of product and its volume. This information is transmitted to the computer terminal 13 which accesses the lookup tables in the central data base and calculates a weight of the product by multiplying the volume of the product and its density. The computer terminal 13 then calculates the price of the product by multiplying the calculated weight and the price/weight ratio. The calculated price is displayed on the terminal and, optionally, printed as part of a running total of purchases made.

Where the product is generally symmetrical (e.g., oranges and other produce), a single camera is all that is required to determine volume from the image. If products are non-symmetrical, two or more cameras or a stereoscopic camera(s) may be required to properly determine the volume of the product. Moreover, a conveyor is not required for the practice of the invention. The product, the weight of which is to be determined may be placed in the field of view of the camera by other means, including manually. In addition, for some types of products, price may be computed based on a weight range. For example, pumpkins might be priced as small (2 to 3 pounds), medium (3 to 6 pounds) and large (over 6 pounds). In that case the weight of the product is first determined, then the product is categorized (e.g., small, medium or large) to determine the price. Optionally, the terminal 13 may be provided with an over ride function so that, if the determined price is incorrect for whatever reason, the price may be manually entered.

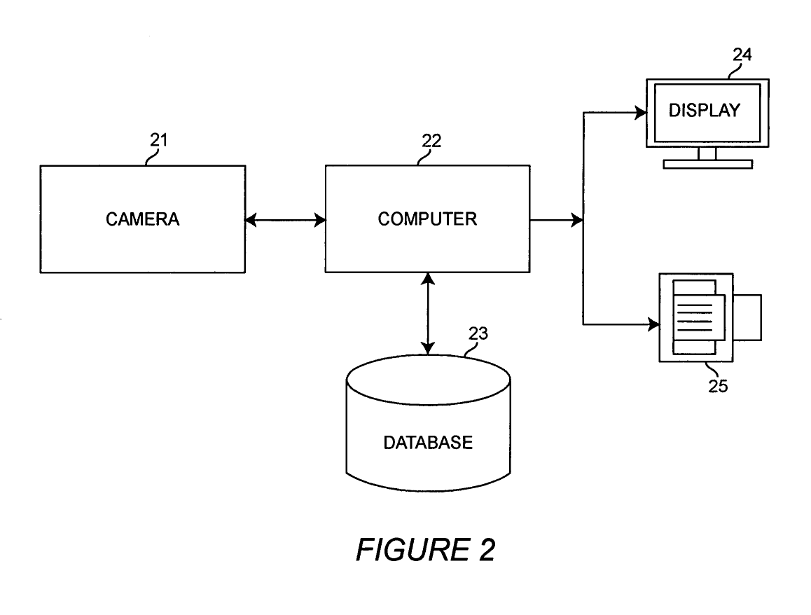

FIG. 2 is a block diagram of the apparatus shown in FIG. 1. The apparatus includes a camera 21 which detects and determines the volume of a product within its field of view. The type of product and its volume information is transmitted to a computer 22 which accesses a database 23 of lookup tables containing densities for products in the store. The computer 22 first calculates a weight of the product as a function of density and volume and then calculates a price of the product as a function of calculated weight and price/weight ratio (e.g., 99¢/lb.). The calculated price is displayed on the computer display 24 for each product as a running total. In addition, the running total can be printed by printer 25 as the close of the transaction.

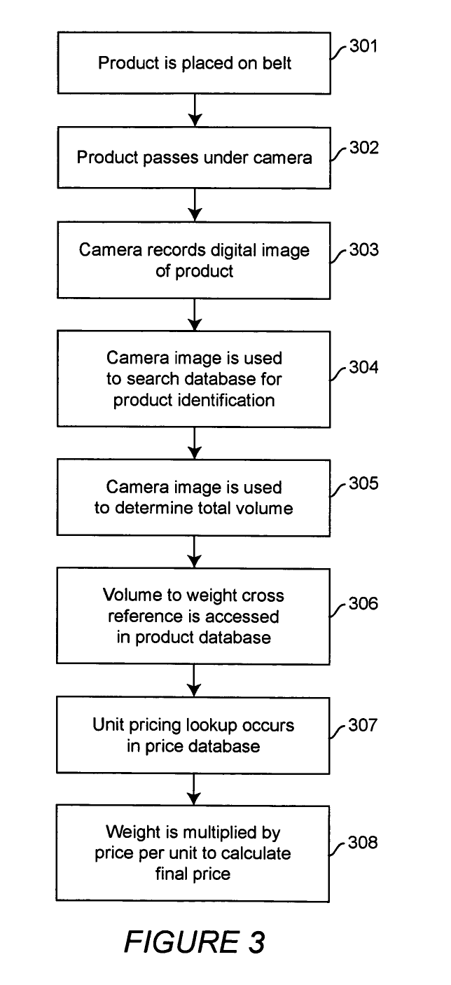

FIG. 3 is a flow diagram of the method of using a camera and associated computer system to determine weight and price for products that normally priced by unit of weight without using a scale. In Step 301, the cashier (or the customer, in the case of self-checkout) places the product on a moving conveyor belt, or holds it under a camera station built into the check out lane. For self-self checkout, this completely eliminates the current need for the customer to identify the product by paging through a catalog and selecting the proper item. In Step 302, the product proceeds to move under a camera station, either by the motion of the belt or by the cashier holding the product as described in Step 301. In Step 303, the camera will record a digital image of the product, and send that image to a computer for processing. In Step 304, the digital image will be compared to a database of images in order to determine the correct product identification. In Step 305, mathematical algorithms are applied to the digital image to determine the exact size (volume) of the product. In Step 306, the product database is accessed to determine the weight-to-size (volume) ratio, using the size determined in Step 305. The correct total weight is then calculated. In Step 307, the existing pricing database within the Point-of-Sale computer software application is accessed, to determine the correct price per unit of weight (e.g., $0.69 per pound). In Step 308, the total weight (Step 306) is multiplied by the price per unit of weight (Step 307) to calculate the correct total price.

This method saves cost; the cost of a camera is less than the cost of a scale. This method saves steps; the cashier/customer no longer must type in a product code or select from a list, the product does not need to be placed on a scale. This method saves time by eliminating steps. This method reduces errors because the cashier/customer can not select the wrong product. This method increases customer satisfaction (for self-checkout) because the customer does not need to understand the system or follow detailed and complicated instructions.

While the invention has been described in terms of a single preferred embodiment, those skilled in the art will recognize that the invention can be practiced with modification within the spirit and scope of the appended claims.

1. Apparatus to determine prices of products priced by weight comprising:
a camera for detecting and identifying a product by type;
means for determining a volume of the product based on image information from the camera;
a database of lookup tables of densities of a plurality of products; and
a computer terminal which receives product type and volume of the product information and accesses the database to determine a density for the product, the computer terminal computing a weight of the product as a function of volume and density of the product and then computing a price of the product as a function of price/weight ratio.

2. The apparatus recited in claim 1, wherein the apparatus is part of a checkout station in a retail store.

3. The apparatus recited in claim 2, further comprising a display connected to the computer which displays the calculated price of the product.

4. The apparatus recited in claim 3, wherein the computer generates a running total of prices for a plurality of products as part of a single transaction and displays the running total on the display.

5. The apparatus recited in claim 3, further comprising a connected to the computer which prints the running total.

6. The apparatus recited in claim 1, wherein the computer terminal categorizes the product within one of a plurality of weight ranges, the price of the product being a function of the weight ranges.

7. A method of determining a product weight and calculating price comprising the steps of:
detecting a product with a camera;
identifying the product by type;
determining a volume of the product from an image of the product;
accessing a database of densities of a plurality of products and determining a density for the detected and identified product;
calculating a weight of the product as a function of volume and density of the product; and
calculating a price of the product as a function of the calculated weight and price/weight ratio.

8. The method recited in claim 7, further comprising the step of displaying the calculated price of the product.

9. The method recited in claim 8, further comprising the step of generating a running total of prices for a plurality of products as part of a single transaction.

10. The method recited in claim 9, further comprising the step of printing the running total upon completing of the transaction.

11. The method recited in claim 7, further comprising the step of categorizing the product within one of a plurality of weight ranges, the price of the product being a function of the weight ranges.
